(19) United States
(12) Patent Application Publication
(10) Pub. No.: US 2026/0107935 A1
(43) Pub. Date: Apr. 23, 2026

(54) AGRICULTURAL SPRAYER SENSOR AND RELATED DEVICES, SYSTEMS, AND METHODS

(71) Applicant: Ag Leader Technology, Ames, IA (US)

(72) Inventors: Jeff Westbrook, Ames, IA (US); John Howard, Ames, IA (US)

(21) Appl. No.: 19/367,636

(22) Filed: Oct. 23, 2025

Related U.S. Application Data
(60) Provisional application No. 63/710,641, filed on Oct. 23, 2024.

(51) Int. Cl. A01M 7/00; A01C 23/00

(52) U.S. Cl. CPC A01M 7/0089; A01C 23/007

(57) ABSTRACT

An agricultural sprayer monitoring system, comprising at least one light source and at least one light sensor positioned near the light source, wherein the at least one light source and at least once light sensor are configured to measure intensity and color spectrum frequences of light passing through a fluid between the at least one light source and the at least one light sensor.

### CROSS-REFERENCE TO RELATED APPLICATION(S)

This application claims the benefit under 35 U.S.C. § 119(e) to U.S. Provisional Application 63/710,641, filed Oct. 23, 2024, and entitled “Agricultural Sprayer Boom Flush, Chemical Detection and Chemical Concentration Detection,” which is hereby incorporated herein by reference in its entirety for all purposes.

### TECHNICAL FIELD

The disclosure relates to agricultural sprayers and liquid applications.

### BACKGROUND

Agricultural sprayers apply various liquid products to various crops. Precise application of the product to the crop is required to avoid over/under application as well as to comply with regulations regarding the use and application of product. Failure to do so may result in inefficient product use, crop damage, and potential operator liability due to regulatory non-compliance.

### BRIEF SUMMARY

Disclosed herein are various devices, systems, and methods for providing real time information regarding the state of the product in the sprayer's liquid application system. This is accomplished by sensing the color spectrum of the product and processing the data to report various metrics to the operator. Exemplary metrics include product concentration, product concentration rate of change, product identification, and thoroughness of product mixing.

Various implementations include use of a light sensor that measures multiple spectra of light (including IR and UV) simultaneously and/or individually of a light being emitted from a light source and directed through a fluid. Various further implementations include use of a multi spectral light source with independently adjustable intensity.

Still further implementations include calibration of the system by adjusting the intensity of the individual spectra of light from the source to levels that maximize the sensitivity of the color sensor for the media being measured.

Certain implementations include application of the sensor to the identification of agricultural chemicals and/or concentration at several locations on a mobile sprayer. In these and other implementations, it would be appreciated that use of a sensor at different locations may provide different functionality for control and/or record keeping.

Some implementations include packaging of a sensor and light source in such a way that integrates the sensor and light source into an agricultural chemical application and handling equipment and integrates with the electronic controls of such equipment. In certain of these implementations, the system may to retrofitted to an existing sprayer or other equipment as would be appreciated and understood by those of skill in the art.

In Example 1, an agricultural sprayer monitoring system, comprising at least one light source and at least one light sensor positioned near the light source, wherein the at least one light source and at least once light sensor are configured to measure intensity and color spectrum frequences of light passing through a fluid between the at least one light source and the at least one light sensor.

Example 2 relates to the agricultural sprayer monitoring system of any of Examples 1 and 3-7, wherein the intensity and color spectrum frequencies measured by the at least one light sensor are transmitted to a processor for determination of one or more of product concentration, product concentration rate of change, product identification, and thoroughness of product mixing of the fluid.

Example 3 relates to the agricultural sprayer monitoring system of any of Examples 1-2 and 4-7, wherein the intensity and color spectrum frequencies measured by the at least one light sensor are transmitted to a processor to determine a signature and wherein the signature is compared to known signatures for various liquid products within a database for product identification.

Example 4 relates to the agricultural sprayer monitoring system of any of Examples 1-3 and 5-7, further comprising a display configured to present a readout of signals from the at least one light sensor.

Example 5 relates to the agricultural sprayer monitoring system of any of Examples 1-4 and 6-7, wherein the light source is a multi-spectral light source with adjustable intensity.

Example 6 relates to the agricultural sprayer monitoring system of any of Examples 1-5 and 7, wherein the at least one light source and the least one light sensor are located on a sprayer bulk tank.

Example 7 relates to the agricultural sprayer monitoring system of any of Examples 1-6, wherein the at least one light source and the least one light sensor are located on a sprayer boom.

In Example 8, a sensor for detecting a state of a liquid applicator, comprising a light source disposed on a first side of a fluid flow channel and a light sensor disposed on a second side of the fluid flow channel substantially opposite the light source, the light sensor configured to sense an intensity and a color spectrum of a liquid flowing through the liquid flow channel between the light source and the light sensor.

Example 9 relates to the sensor of any of Examples 8 and 10-15, wherein the light source is a multi-spectral light source and adjustable intensity.

Example 10 relates to the sensor of any of Examples 8-9 and 11-15, wherein the light source and light sensor may be calibrated by adjusting the light intensity.

Example 11 relates to the sensor of any of Examples 8-10 and 12-15, further comprising at least one processor in communication with the light sensor and at least one database in communication with the processor, the database comprising product signature for various products that may be present in the fluid flow channel.

Example 12 relates to the sensor of any of Examples 8-11 and 13-15, wherein the sensed intensity and color spectrum of light of the liquid flowing through the flow channel comprise a signature and wherein the signature is compared to product signatured store in the database for product identification.

Example 13 relates to the sensor of any of Examples 8-12 and 14-15, wherein the processor is configured to determine one or more of product concentration, product concentration rate of change, product identification, and thoroughness of product mixing of the liquid.

Example 14 relates to the sensor of any of Examples 8-13 and 15, wherein the liquid applicator is an agricultural sprayer and the liquid flow channel is a sprayer boom.

Example 15 relates to the sensor of any of Examples 8-14, wherein the liquid applicator is an agricultural sprayer and the liquid flow channel is a bulk tank.

In Example 16, an agricultural sprayer system, comprising a light source, a light sensor located near the light source and configured to measure an intensity and at least one color of light passing through a fluid from the light source, a processor in communication with the light sensor configured to generate a product signature from the measured intensity and at least one color of light, and a database comprising stored known product signatures herein the product signature is compared to the known product signature for product identification.

Example 17 relates to the agricultural sprayer system of any of Examples 16 and 18-20, wherein the processor is further configured to determine one or more of product concentration, product concentration rate of change, and thoroughness of product mixing of the liquid.

Example 18 relates to the agricultural sprayer system of any of Examples 16-17 and 19-20, wherein the light source is a multi-spectral light source with adjustable intensity.

Example 19 relates to the agricultural sprayer system of any of Examples 16-18 and 20, wherein the light source and light sensor may be calibrated by adjusting the light intensity.

Example 20 relates to the agricultural sprayer system of any of Examples 16-19, further comprising a display configured to present a readout of signals from the at least one light sensor.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a system diagram showing use of a sensor near a sprayer nozzle, according to one implementation.

FIG. 2 is a system diagram showing use of a sensor on a sprayer boom, according to one implementation.

FIG. 3 is a schematic system diagram, according to one implementation.

FIG. 4 shows an exemplary sensor output graph at various points during use, according to one implementation.

FIG. 5 shows exemplary sensor output having been variously filtered, according to one implementation.

### DETAILED DESCRIPTION

Described herein are various devices, systems, and methods for controlling, analyzing, and providing information regarding the performance of an agricultural system, particularly a sprayer or other liquid applicator. In various of these implementations, a light source emits light through a flow passage within the liquid application system. Through an opening on the opposite side of the flow passage, a light sensor is used to detect the light that is transmitted through the fluid in the flow passage. The light sensor is located such that it may measure the light that is transmitted through the fluid. The light source and sensor pair may be located in a bulk tank, spray boom pipe, or any fluid conduit in a liquid system.

The light source and sensor may be capable of transmission and sensing of the visible light spectrum, ultraviolet, and/or infrared wavelengths. The light source may provide white light (all color spectrum frequencies) or specific color spectrum frequencies of visible light as well as ultraviolet and infrared spectrums. The light sensor is configured to detect the intensity and light color spectrum content of the light that was transmitted through the liquid product in the flow passage.

The data from the light sensor may be post processed by a microprocessor to identify the intensity of the light within each sensed color range. In various implementations, the collection of color intensity levels in each sensed color range, along with transient information such as direction and rate of change of intensity levels form a signature for a given liquid product, concentration level, and mix quality of combinations of products. Optionally, comparing the measured signature with a database of known products enable the identification of the product and attributes thereof.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sept. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sept. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices, and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensor and Related Devices, Systems, and Methods,” U.S. Patent Application 63/720,611, filed Nov. 14, 2024, entitled “Liquid Product Distribution for See and Spray Systems,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/727,579, filed Dec. 3, 2024, entitled “Smart Shift for Automatic AB Line Adjustment in Agricultural Operations and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” each of which is incorporated herein by reference.

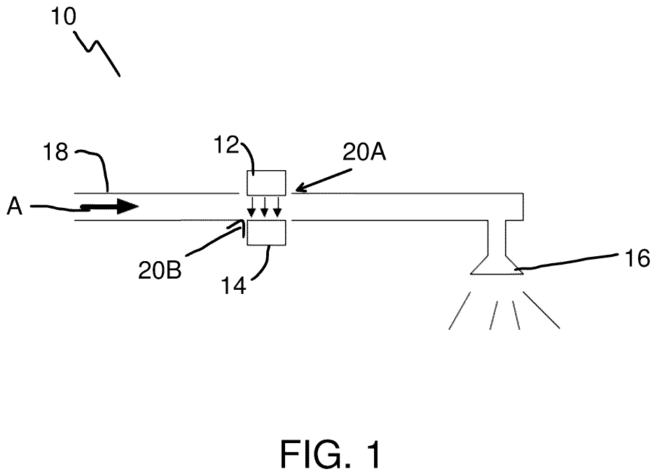

The devices, systems, and methods disclosed and discussed herein may be applied in many ways, as would be understood and appreciated by those of skill in the art given the various example described herein. In one application, seen in FIG. 1, the light source 12 may be located to be directed/shine through an opening 20A in a flow passage 18 (optionally a spray boom) and through an opening 20B on the opposite side of the flow passage 18. A light sensor 14 is then used to detect the light that is transmitted through the fluid A in the flow passage 18. The light sensor 14 detects the intensity and light color spectrum content of the light that was transmitted through the liquid product A in the flow passage 18. The data from the light sensor 14 is optionally post processed by a microprocessor, as described further herein, to identify the liquid and/or characteristics thereof.

In some implementations, the light source 12 and light sensor 14 may be located near the spray nozzle 16, as shown in FIG. 1. In these implementations, the sensor 14 data may be collected close in time when the product A is outputted out of the spray nozzle 16.

### Sprayer Boom Clean Out and Priming

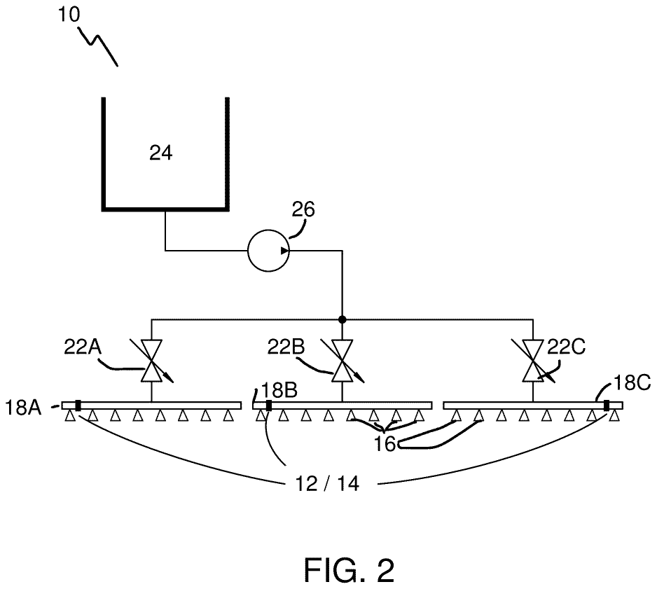

Optionally, to detect when a flow passage 18, such as a spray boom, has been filled with water (such as for clean out) and/or with a chemical product (such as to prime), a light source 12 and sensor 14 may be placed in a spray boom 18 line in each boom section 18A, 18B, 18C, shown in FIG. 2. As would be understood, each section 18A, 18B, 18C may be controlled individually by an electrically actuated shutoff valve 22A, 22B, 22C. In these and other implementations, the light source 12 and sensor 14 may be located near an end of the pipe opposite where the liquid enters the section, shown for example in FIG. 2. Various alternative locations for the light source 12 and sensor 14 are possible and would be understood.

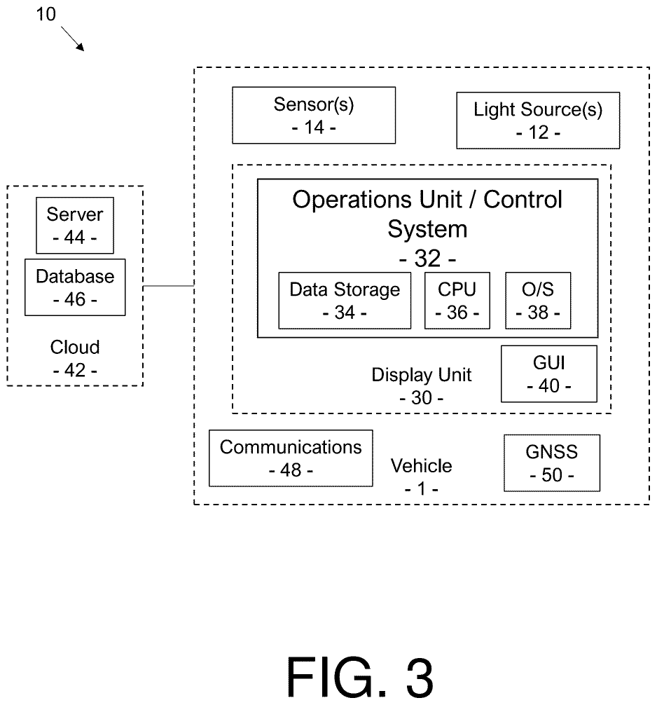

When, during a priming or cleanout operation, the sensor 14 and system 10 determines the liquid has changed from chemical to water or vice versa, a signal can be sent to the master control system 32 (described further in relation to FIG. 3) to indicate to the user that the operation is complete and to manually or automatically close a particular boom section valve 22. This functionality may optionally reduce the amount of chemical wasted on the ground and/or potentially damaging the spot of ground where the priming/cleanout takes place. Various additionally benefits would be recognized by those of skill in the art.

### Chemical Identification

In various implementations, the sensor 14 is a color sensor, and may also be used to identify what chemical is in a bulk tank 24 or flow passage 18. This is done in a similar manner to the cleanout/prime function, discussed above, where the detected signature of the chemical is compared to a database of chemicals.

As would be understood, detecting and showing the chemical identity to a user through a display (shown at 30 in FIG. 3) may help reduce mistakes of misapplication of products. Further the sensor 14 and system 10 may allow for verification of product presence which may be useful to an operator for myriad purposes as would be understood and as described herein.

The information, regarding chemical identity, signature, and the like, may also be stored in a data log 34 in the display 30 for record keeping of farming input practices during the year, as well as possible verification of compliance with current or future governmental regulations covering agricultural chemical application and handling.

### Chemical Concentration

As would be understood, often, agricultural chemicals are sold in a concentrate form that is later diluted prior to application. The resultant concentration of solution is sometimes regulated by law and often required manual dilution. The system 10 and sensor 14 may be used to not only identify the chemical in the solution, but the concentration of that chemical.

This concentration information can be used to assist the applicator to automatically or manually adjust the equipment settings to mix the correct concentration of chemical. Further, the concentration measurement may be used in a closed loop chemical injection process where the injection rate is automatically adjusted to reach the correct concentration level.

The sensor 14 reading and logged data can be used for verification and documentation for regulatory compliance, as would be understood and appreciated.

### Chemical Injection Mix Quality

Some agricultural chemical applicators do not mix the concentrated chemical with water in a bulk tank 24, but inject the concentrated chemical directly into the flow downstream of the liquid pump 26. It would be understood that in most applications, a chemical is most effective if it is thoroughly mixed prior to being sprayed. The system 10 and sensor 14 optionally the ability to detect non-steady state (changing with time) patterns which is an indication of poor mix quality.

A mix quality measurement may help a user manually or the system 10 automatically adjust chemical injection equipment settings to improve the thoroughness of the mixing of the injected chemical.

### Product Contamination Detection

Another fluid condition that is detectable by the system 10 and sensor 14 is the presence of solid particles. Solid particles in the fluid can lead to premature wear and nozzle plugging. In various implementations, the system 10 may alert the user of solid particles through the display 30 so that proactive maintenance can be taken, such as cleaning a tank or filter.

### System Components

Turning to FIG. 3, in various implementations the system 10 is implemented on a sprayer 1 or other agricultural vehicle 1 capable of fluid application, as would be understood. In various implementations, the system 10 includes one or more light sources 12 and associated sensors 14 in operational communication with a vehicle system display 20, such as the InCommand® display from Ag Leader®, and an operations unit 32. The system 10 optionally comprises various additional sensors, monitors and the like, as would be appreciated by those of skill in the art and as disclosed in various of the incorporated references.

The system 10 and various components thereof may be integrated with additional system and devices the vehicle, such as sprayer controls and the like. As would be understood, various additional systems and devices on the vehicle or associated therewith, such as sprayer controls are configured to take outputs/instructions from the operations unit 32.

Continuing with FIG. 3, in various implementations, the system 10, optionally integrated within the display 30, is an operations unit 32 in operational communication with data link 48 (also referred to herein as a communications component 48). It is generally understood that these components may optionally be housed within the display unit 20 and that the representation of FIG. 3 is merely exemplary.

In certain implementations, the operations unit 32 is also configured for the sending and receiving of data for storage and processing, such as to the cloud 42, a remote server 44, database 46, and/or other cloud computing components readily understood in the art. Such connections by the operations unit 32, can be made wirelessly via understood internet and/or cellular technologies such as Bluetooth, Wi-Fi, LTE, 3G, 4G, or 5G connections, and the like. It is understood that in certain implementations, the operations unit 32 and/or cloud 42 component may comprise encryption or other data privacy components such as hardware, software, and/or firmware security aspects.

Continuing with FIG. 3, the operations unit 32, according to certain implementations, further has one or more optional processing and computing components, such as data storage 34, a CPU or processor 36, an operating system (“O/S”) 38, a user interface (“GUI”) 59 and other computing components necessary for implementing the various technologies disclosed herein. It is appreciated that the various optional system components are in operational communication with one another via wired or wireless connections and are configured to perform the processes and execute the commands described herein. As would be understood, each of these components can be located optionally at various locations around the vehicle or elsewhere, such as in the cloud 42 and accessible by a wireless or cellular connection.

In various implementations, this connectivity means that an operator, enterprise manager, and/or other third party is able to receive notifications such as adjustment prompts and confirmation screens on their mobile devices or via another access point. In certain implementations, these individuals can review the various data collected or recorded by the system 10 and make adjustments, comments, and/or observations in real-time or near real-time, as would be readily appreciated.

As shown in FIG. 3, the system 10 includes at least one light source 12 and associated sensor 14 that is in operational communication with the system 10 and operations unit 32 via the communications component or data link 48. It is understood that in certain implementations, the light source 12 and sensor(s) 14 are in direct operational communication with the operations unit 32, and that it is calibrated to utilize raw data values generated by those sensors 14 to perform various spraying and mixing related tasks as is discussed in further detailed herein.

### Sensor Calibration

In various implementations, to improve the sensitivity of the sensor 14 the light source 12 intensity is adjusted in each spectral band such that the sensor 14 is operating in a sensitive part of its sensing range. This adjustment may be done for each application location (boom pipe 18, bulk tank 24, rubber vs. stainless steel pipe, etc.) in order to compensate for differences in light reflection and absorption in each location.

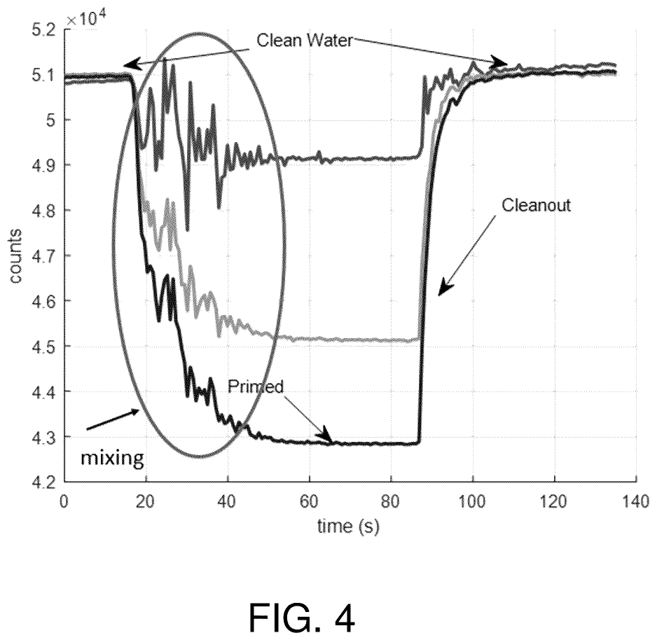

In one exemplary light sensor 14 calibration algorithm, the intensity of a red, green and blue (RGB) light source may be controlled by a microprocessor 36 as it reads the 16-bit red, green and blue brightness levels from the light sensor 14. To improve the light sensor 14 resolution, the processor 36 may individually adjust the red, green and blue brightness such that the red, green and blue brightness scale is 80% saturated when the spray boom 18 only contains water with no product. FIG. 4 at 0 to 15 seconds shows where the brightness is at 80% (approximately 51,000 counts) of the 16 bit (65,536 count) sensor 14 range.

In presenting the light sensor 14 data to the operator, one optional method includes reading the raw data and observing rate of change (slope) and variability over time of the sensor's 14 indicated RGB brightness. In practice, this may look like FIG. 4 from 15 to 40 seconds, where initially, the light sensor 14 is viewing clear water and then product is added and not initially mixed well as noted by the RGB count variability.

As the product mixing becomes complete and the product concentration (priming) reaches steady state, the red, green and blue rate of change, i.e.—slope approaches zero and the variability stabilizes. This visual would indicate to the sprayer operator that the product is in the boom, mixed well and its concentration has stabilized. See FIG. 4 from 60 to 85 seconds.

At the end of the spraying operation, it is often good practice to clean out a spraying system by flushing with water. Again, using the light sensor's 14 RGB values in real time, the operator may observe the process in reverse where fresh water is used to clean out the boom 18 of product and watch as the RGB values stabilize back to the initial sensor calibration RGB brightness. See FIG. 3 from 85 to 130 seconds.

In various implementations, a user may be presented a visual graph similar to that in FIG. 3 on a display 30 during operations. In certain further implementation, the raw data (like that of FIG. 3) may processed and displayed to a user on the display 30 as a readout, indicator light, or otherwise to show the desired information to the operator.

Another implementation may include post processing data to display when mixing and priming operations are complete as well as when cleanout operations are complete. By filtering the data with a low pass filter and noting the direction and magnitude of the slope, the beginning and end of the mixing/priming process and the cleanout operation may be determined.

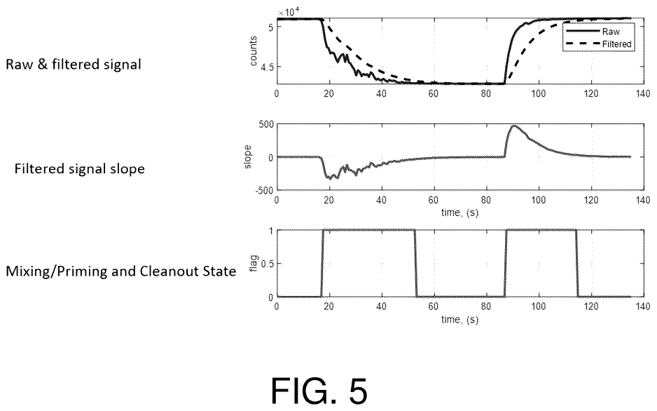

In FIG. 5, a low pass filter is applied to blue light intensity signal data from FIG. 4. The filtered signal slope is plotted noting if the slope is positive or negative. A negative slope indicates mixing/priming is occurring and a positive slope represents cleanout is taking place. Threshold values for a negative and positive slope are applied to provide an indication for what operation is occurring (mixing/priming or cleanout), when it begins, when it ends and how thorough the mixing/priming and cleanout are. The various thresholds may be entered by a user, programmed by a manufacture, learned by the system 10 such as via artificial intelligence, or the like as would be understood.

In FIG. 5, from 15 to 20 seconds, the slope (rate of change) of the filtered data became negative. A negative slope indicates mixing/priming is occurring. When the threshold limit is exceeded, as shown by the state change from zero to one, it indicates to the operator that active mixing/priming is occurring. As the mixing/priming near completion, the slope begins to approach zero and once it crosses the slope threshold the state returns to zero (mixing/priming is complete). See FIG. 5 from 40 to 60 seconds. The threshold value may be used to set limits on how complete or not the mixing/priming operation need to be for the operation to be called complete.

Further implementations including having the operator alerted when there is significant—above a threshold amount of—variability in the light sensor 14 signal which may indicated poor product mixing.

Still further implementations include a sensor 14 located in the sprayer tank 24 where the operator may verify the chemical concentration prior to priming the spray boom 18. The product concentration may be accomplished by mapping a product's characteristic light absorption properties, or color spectrum signature, at two or more concentration levels allowing for interpolating the product concentration that is in the tank.

Identification of the product by the system 10 and sensor 14 may be accomplished by matching the color spectrum signature against a stored database of signatures for multiple products.

Still further implementations include alerting an operator when there is significant—more than a threshold amount of—variability in the signal accompanied by color signature that does not match the current product's color signature. This may indicate there is contamination such as the previous product not being flushed properly or particulate contamination in the flow passage.

Using the light sensor's 14 output for several concentration levels of product and then interpolating the allows the operator/system to verify the actual real-time concentration of product that is being sprayed matches the expected concentration.

Although the disclosure has been described with references to various embodiments, persons skilled in the art will recognize that changes may be made in form and detail without departing from the spirit and scope of this disclosure.

What is claimed is:

1. An agricultural sprayer monitoring system, comprising:
(a) at least one light source; and
(b) at least one light sensor positioned near the light source,
wherein the at least one light source and at least once light sensor are configured to measure intensity and color spectrum frequences of light passing through a fluid between the at least one light source and the at least one light sensor.

2. The agricultural sprayer monitoring system of claim 1, wherein the intensity and color spectrum frequencies measured by the at least one light sensor are transmitted to a processor for determination of one or more of product concentration, product concentration rate of change, product identification, and thoroughness of product mixing of the fluid.

3. The agricultural sprayer monitoring system of claim 1, wherein the intensity and color spectrum frequencies measured by the at least one light sensor are transmitted to a processor to determine a signature and wherein the signature is compared to known signatures for various liquid products within a database for product identification.

4. The agricultural sprayer monitoring system of claim 1, further comprising a display configured to present a readout of signals from the at least one light sensor.

5. The agricultural sprayer monitoring system of claim 1, wherein the light source is a multi-spectral light source with adjustable intensity.

6. The agricultural sprayer monitoring system of claim 1, wherein the at least one light source and the least one light sensor are located on a sprayer bulk tank.

7. The agricultural sprayer monitoring system of claim 1, wherein the at least one light source and the least one light sensor are located on a sprayer boom.

8. A sensor for detecting a state of a liquid applicator, comprising:
(a) a light source disposed on a first side of a fluid flow channel; and
(b) a light sensor disposed on a second side of the fluid flow channel substantially opposite the light source, the light sensor configured to sense an intensity and a color spectrum of a liquid flowing through the liquid flow channel between the light source and the light sensor.

9. The sensor of claim 8, wherein the light source is a multi-spectral light source and adjustable intensity.

10. The sensor of claim 9, wherein the light source and light sensor may be calibrated by adjusting the light intensity.

11. The sensor of claim 8, further comprising at least one processor in communication with the light sensor and at least one database in communication with the processor, the database comprising product signature for various products that may be present in the fluid flow channel.

12. The sensor of claim 11, wherein the sensed intensity and color spectrum of light of the liquid flowing through the flow channel comprise a signature and wherein the signature is compared to product signatured store in the database for product identification.

13. The sensor of claim 11, wherein the processor is configured to determine one or more of product concentration, product concentration rate of change, product identification, and thoroughness of product mixing of the liquid.

14. The sensor of claim 7, wherein the liquid applicator is an agricultural sprayer and the liquid flow channel is a sprayer boom.

15. The sensor of claim 10, wherein the liquid applicator is an agricultural sprayer and the liquid flow channel is a bulk tank.

16. An agricultural sprayer system, comprising:
(a) a light source;
(b) a light sensor located near the light source and configured to measure an intensity and at least one color of light passing through a fluid from the light source;
(c) a processor in communication with the light sensor configured to generate a product signature from the measured intensity and at least one color of light; and
(d) a database comprising stored known product signatures herein the product signature is compared to the known product signature for product identification.

17. The agricultural sprayer system of claim 16, wherein the processor is further configured to determine one or more of product concentration, product concentration rate of change, and thoroughness of product mixing of the liquid.

18. The agricultural sprayer system of claim 16, wherein the light source is a multi-spectral light source with adjustable intensity.

19. The agricultural sprayer system of claim 18, wherein the light source and light sensor may be calibrated by adjusting the light intensity.

20. The agricultural sprayer system of claim 16, further comprising a display configured to present a readout of signals from the at least one light sensor.
